(19) United States
(12) Patent Application Publication
(10) Pub. No.: US 2007/0177162 A1
(43) Pub. Date: Aug. 2, 2007

(54) Device for measuring changes in the position of the edge of a body

(75) Inventor: Stefan Glueck, Niederwerrn (DE)

Correspondence Address: LUCAS & MERCANTI, LLP, 475 PARK AVENUE SOUTH, 15TH FLOOR, NEW YORK, NY, 10016, US

(73) Assignee: Schaeffler KG, Schweinfurt (DE)

(21) Appl. No.: 10/593,160

(22) PCT Filed: Mar. 18, 2005
(86) PCT No.: PCT/DE05/00515

§ 371 Date: Dec. 1, 2006

(30) Foreign Application Priority Data
Mar. 18, 2004 (DE) 10 2004 013 683.1

(51) Int. Cl. G01B 11/14

(52) U.S. Cl. 356/621

(57) ABSTRACT

The invention relates to a measuring device for measuring changes in the position of the edge of a body of a component. Said measuring device contains a sensor which reacts to the changes, a light source, a measuring edge fixed in relation to the edge of the body, and a light emitted from the light source. From the change in position, information about the deformation caused by a force F (for example, in the case of bearings) can be obtained, a weight or an imbalance can be determined, and joints and press fits can be monitored. The measurement is carried out by reflection or transmission, preferably using optical waveguides.

### FIELD OF THE INVENTION

The invention relates to a measuring device for measuring changes in at least the position of at least one body edge of a component, the measuring device having at least one sensor reacting to the changes.

### BACKGROUND OF THE INVENTION

Such a measuring device is described in DE 27 46 937 C2. Forces on rolling bearings are measured with the aid of strain gauges as sensors. In this case, sensors that are in contact with the bearing rings react to elastic deformations of the bearing rings. The sensors are, for example, fixed on body surfaces of the bearing that are located in the region of the load zones such that variations such as instances of arching of the roundness at the surfaces/edges are possible to detect. It is relatively elaborate to produce and fit such strain gauges. Moreover, the strain gauges are sensitive to temperatures and to mechanical influences. A relatively elaborate, and therefore expensive electronic evaluation system is required for evaluating the signals supplied by the sensors.

### SUMMARY OF THE INVENTION

At the time when the invention was devised, the object was to provide a simple, reliable, robust and cost effective measuring device which can be used for the reliable detection of all conceivable variations in the position and the shape of body surfaces, and thus deduced therefrom, variations in the position and the shape of individual body edges.

This object is achieved according to the characterizing part of claim 1 by means of an optical measuring device having the following features:
The measuring device has at least one light source. All conceivable technical light sources such as, for example, light-emitting diodes, laser sources, infrared light sources, lamps etc. are provided as light source.
The measuring device has at least one measuring edge that is fixed in relation to the body edge. The measuring edge can optionally be a constituent of an edge that is, for example, loaded mechanically or by thermal expansions, or directly a constituent of a surface, composed of many of the edges, on the component, or a constituent of an aperture arranged on the component in the vicinity of the deformation.
An aperture in this sense is a gap, a slot or a bore or a passage fashioned in some other way and at whose edge a portion of the light from the light source is held back and through which the other portion of the light strikes the sensor or a reference reflector without impediment. The aperture is therefore a device for restricting the cross section of bundles of rays. However, as an alternative the slot can also be formed in a component between two components situated opposite one another. The aperture is adjusted by changes in shape and/or position at the component.
The measuring device has at least one light emanating from the light source. The type of light, as a rule a bundle of rays, can be alternatively selected and is dependent on the selected light source.
The measuring edge or body edge is at least variable in position, starting from an initial position. In this sense, the variations in the position are also deformations at the body edge, displacement in the position of the body edge owing to wear and aging, or the like. A portion of light which can be variable in size by changes in the position of the measuring edge strikes the sensor without impediment. One or more of the measuring edges delimit a light aperture. The other portion of the light is held back by the edge(s) or at the edge(s) and the material of the component that adjoins the edges, being alternatively reflected or absorbed. The edge(s)/apertures move analogously to the deformations or variations at the component. The aperture influences the brightness of the light that falls onto the sensor through the aperture. The transmitting size or the shape of the aperture changes as a function of the deformations and/or displacements at the component(s). As an alternative, the measuring edge is a body edge of the component itself.
The sensor(s) is/are, depending on the light source selected, all suitable technical light receivers such as photosensitive resistors, photodiodes, phototransistors or the like.

The measuring device is provided for measuring changes in the position of the component, or of regions of the component that are caused, for example, by influences of force on the component, one or more measuring edge(s) or a body edge(s) of the component optionally being used as a variable aperture. The component is arranged, for example, such that it can move at least in a restricted fashion in relation to a second component. Forces applied to the component lead to the displacement of the component by comparison with the second component. Such displacement can be measured by the device when, for example, a measuring edge of the component being displaced approaches a component situated opposite the body edge at a slot, or moves away therefrom. The sensor then detects the change in the slot by means of the changed transmission of light by the slot.

It is also conceivable to detect the load on a component with the aid of elastic deformations at a passage introduced into the component. The passage takes the form of a through bore or of a slot. The body edge(s) restrict(s) the smallest free cross section of the passage continuously or with interruptions.

Alternatively, the measuring device is optionally provided for measuring changes in position from changes in shape without the action of force on at least one section of the component. Such deformations or displacements result from thermal distortion or from wear, from instances of shrinking, from material loss owing to aging, for example with plastics. The measuring edge is here a body edge of the component.

The measuring device is to be used, for example, in washing machines. In this case, the device detects deformations or displacements from the weight of the laundry introduced into the drum of a washing machine. The weight of the laundry detected with the aid of the measuring device is then used, for example, to regulate the amount of water required for the washing operations. Furthermore, in this application the measuring device can be used to detect deformation or displacement owing to excessively high forces as a consequence of unbalanced masses.

It is also conceivable that in an initial position of the measuring edge the light is wholly impeded from striking the sensor at least by the measuring edge and the adjoining material. For example, such an arrangement can be used to monitor a contact point between two or more components that lie in a fashion touching one another in the normal position or move on one another while touching. Examples are, for instance, the contact points of seals or snug fits between, for example, components loaded by pressure. In the initial position of the components, the light is directed onto the seat to be monitored. If a gap is produced at the sealing point by wear or by aging or by overloading at the snug fit, at least a portion of the light passes through the gap to the sensor, which reacts appropriately with signals to an evaluation unit.

Alternative embodiment of the invention provide the arrangement of the components of the measuring device with the following features:
The light source and the sensor are situated opposite one another. A portion of the light strikes the measuring edge between the light source and the sensor and does not pass through the aperture. The other portion of the light reaches the sensor through the aperture. In this case, for example, the component is situated between the light source and the sensor.
The light source is situated opposite a reflector. A portion of the light strikes the measuring edge between the light source and the reflector and does not pass through the aperture. The other portion of the light reaches the reflector through the aperture. In this case, for example, the component is situated between the light source and the reflector. The reflector reflects the light at least partially to the sensor. In this case, the sensor can optionally either be arranged on the side of the component where the light source is located, or on the side of the reflector.
A number of edges on a common or on different components are monitored with a sensor. Thus, a measuring device is provided that has a sensor and a number of light sources respectively directed onto different apertures. One of the light sources is then respectively switched on by suitable two-way circuits, while the others are switched off at this instant. The brightness striking the sensor by way of the aperture illuminated by the light is being monitored at this instant. Further in the sequence, this light source is then switched off and another light source is switched on at another aperture. The intensity of the light coming through this other aperture is now monitored etc. in an alternation of any user0defined sequence.
The light source and/or the sensor are arranged in a fashion remote from the aperture or the component. The light is guided from the light source to the aperture or the reference sensor respectively, and/or from the aperture to the sensor or the reflector respectively, by means of light guiding media. Media are to be understood as light guiding substances or structures such as fiber optics cables, rigid light guides such as glass or plastic or liquid or gaseous light guiding media.

The lack of reference to the brightness of the light as reference variable, instances of aging of the light source or of the sensor, the influence of the temperature and, resulting therefrom, change in the properties of sensors, fluctuations in the power supply, and thus falsifications of the measured values must be avoided. Consequently, it is provided in further embodiments of the invention that the measuring device has a first sensor and a second reference sensor and/or that the measuring device has, in addition to at least one light source, at least one reference light source. The arrangement, calibration and functioning of such measuring devices are described in more detail in the chapter entitled “Detailed description of the drawings”.

The measuring device according to the invention can be produced easily and cost effectively. It is possible to use mass produced standardized components that are cost effective and robust. The evaluation of the signals from the sensors and the technique for the evaluation device are not complicated. Fitting the device in the systems to be monitored is easy. The installation space required for accommodating the measuring device is small. The components can easily be provided with the required apertures. The apertures themselves can be designed for any desired loads without this impairing the intended functioning of the component and without the consequent need for sensor systems of a different sensitivity.

### DETAILED DESCRIPTION OF THE DRAWINGS

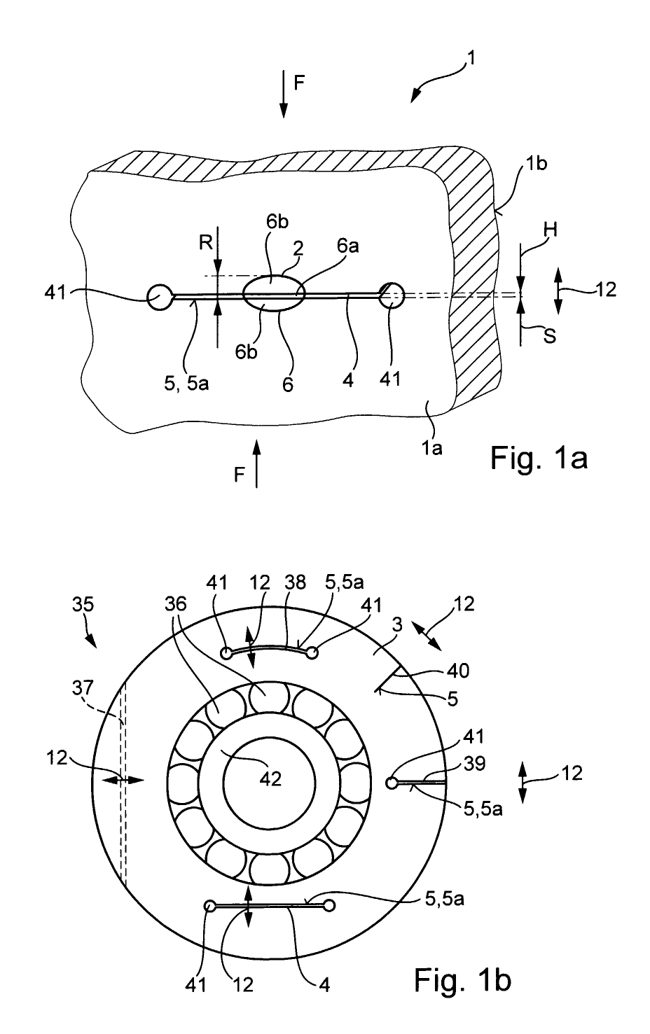

FIG. 1a shows a partial view of a component 1 having a passage 4. The component 1 can be a bearing component 3 according to FIG. 1b, the part of a housing, or else a rubber spring element or similar. The component 1 has a passage 4 in the form of a slot, penetrating the component 1. Further passages 37, 38, 39, 40 are illustrated by way of example in FIG. 1b. The passage 4, 38 is designed transverse to its direction of passage either in a continuously closed fashion or, like the passages 39, 40 in FIG. 1b, in a fashion open at the side. The passages 4 and 39 are delimited by a continuous measuring edge 5 in FIG. 1a, and by an interrupted measuring edge 5 in FIG. 1b. The measuring edge 5 corresponds to a body edge 5a of the component 1 or 3. The passage 4, 38, 39 merges at least toward one side into a through hole 41 that fashions the passage 4, 38, 39 elastically in the direction of the double arrows 12. Alternative passages are circular or of any desired shape. The passage 37 passes through the bearing component 3 tangentially.

FIG. 1b shows a rolling bearing 35 having rolling elements 36 and having the bearing component 3 that can, for example, be an outer ring or a flange. It is also conceivable to construct one or more of the passages 4, 37, 38, 39 or 40 of identical or different design either on the inner ring 42 or on the bearing component 3 or on both, and to provide them with the described light sensor system.

Light 6 is represented exemplary in a projection 2 of a bundle of rays striking side 1a of the component 1 in an unloaded initial state. As a bundle, the light 6 can have in the projection any desired geometric shapes such as circles or such as the elliptical shape illustrated. A portion 6a of the light 6 has a height H that corresponds to the height S of the passage. The portion 6a of the light 6 passes through the passage 4. Starting from the body edge 5a or the measuring edge 5, the portions 6b of the light 6 strike the component and respectively have the height R. The portions 6b are either reflected or absorbed at the body edge 5a and at the component 1, but not admitted through the passage 4.

The size S of the gap S of the passage 4 can be varied continuously within limits when the component 1 is, for example, subjected by the forces F, in the same direction as the double arrow 12, to tensile loading or, in the opposite direction, to compressive loading. The limits are, as a rule, fixed in both loading directions of tension and pressure by the distance the component 1 at the passage 4 in gap S can deflect elastically without lasting plastic deformation or spring back in the direction of the double arrow. If the dimension S is reduced by a fraction as a consequence of compressive loads F, for example, the height H of the transmitted portion 6a is simultaneously reduced, and the height R of the portions 6b is simultaneously increased by that fraction (at least on one side of the body edge 5a). A smaller portion 6a is therefore transmitted through the passage 4. If the component 1 is subjected to tensile loading in the opposite direction, the gap S increases, and the portion 6a which is transmitted through the passage 4 is also increased. The results in both cases are changed brightnesses of the light emerging from the passage 4 on side 1b in comparison to the initial state with unchanged gap S.

It is important that the light 6 striking on the passage 4 and the body edge 5a always has a portion 6b even in the case of the largest possible change in the gap S, and thus the largest possible change in the position of the body edge 5a in at least one direction of the double arrows 12.

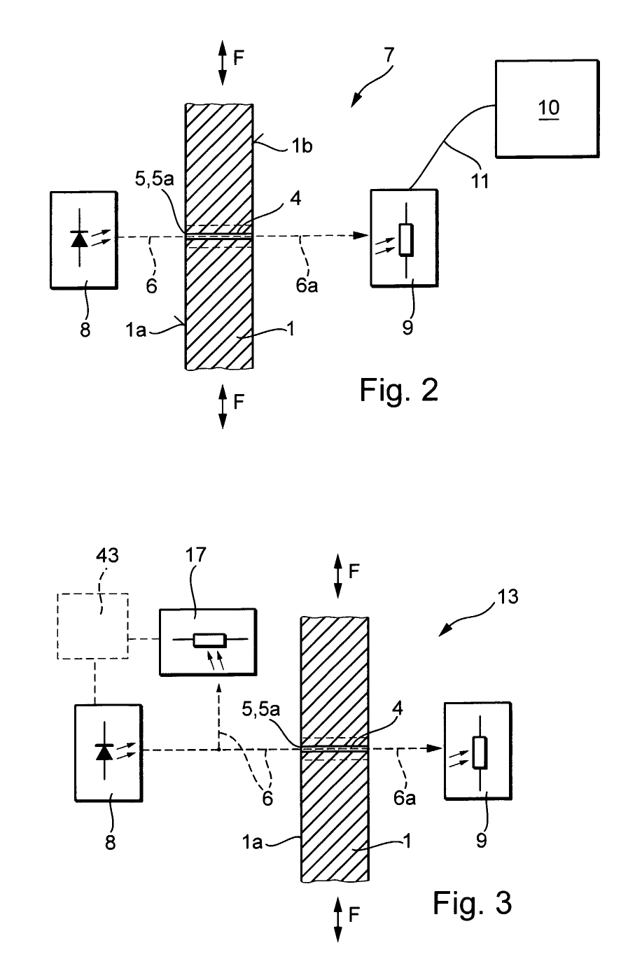

FIG. 2 shows a measuring device 7 on the component 1. The measuring device 7 has a light source 8 that emits the light 6. In this case, the light source is represented exemplary by a symbol for a light-emitting diode. Arranged furthermore in the measuring device 7 are at least one sensor 9 and an evaluation unit 10 that are interconnected by means of a connection 11. After the measuring device 7 has been fitted on the component or in the vicinity thereof, the parts of the light source 8, the sensor 9 and of the passage 4 lying open to the ambient light are encapsulated in a lightproof fashion (not illustrated).

The light 6 is transmitted in part through the passage 4 and strikes the sensor 9. The quantity of light of the part 6a is converted in the sensor into an electric signal. The electric signals are conducted via the connection 11 to the evaluation unit 10. In the event of an unchanged passage 4, that is to say in the initial position of the body edge 5a, a quantity of light 6a emerging at this instant from the passage on the side 1b and striking on the sensor 9 is converted into a signal. The signal is conducted to the evaluation unit and evaluated there and recorded as initial state. The quantity of light incident on the sensor 9 changes in the event of deformations of the passage 4 as a consequence of the changes in position of the body edge 5a. Signals deviating in magnitude from the initial state are conducted to the evaluation units and compared in the latter with the initial state.

The measuring device 7 and measuring devices 13, 14, 15 and 32 described below are suitable, for example, for determining and/or evaluating unbalances in a bearing (not illustrated) in a simple way. The changing forces owing to the unbalances lead to deformations of different magnitude at the passage 4. The gap S changes periodically, and this leads at the sensor 9 to an alternating signal that changes periodically in accordance therewith. The amplitude of the alternating signal that can thereby be detected at the evaluation unit 10 can, for example, be detected there as a direct measure of the magnitude of the unbalance. In addition, the frequency of the signal can be used to determine the periodicity of the unbalance. By comparing the periodicity with the shaft revolution, the interference resistance can be influenced against external vibration. Given suitably fast and sensitive electronics, the devices 7, 13, 14, 15, and 32 make measurement of vibrations possible that signal coming bearing damage.

The measuring devices 13, 14 and 15 and 32 described below are comparable in basic design and function to the measuring device 7. They also function according to the principle previously described. Consequently, the same reference symbols have been selected for the individual parts of the basic design in the following description.

In addition to the basic design of the device 7, the measuring device 13 according to FIG. 3 has a sensor 17 with the function of a reference sensor. The sensors 17 and 9 are illustrated symbolically as a photosensitive resistor. The sensor 17 is arranged in the vicinity of the light source 8 such that during the operation of the measuring device 13 and in a fashion that is continuous and lacks the influences of the deformation on the passage 4, the entire light 6, or at least an invariable fraction from the two portions 6a and 6b, falls thereon. In the evaluation unit (10) the values of the reference sensor 17, which are not varied in relation to the initial state, are compared to the variable value of the sensor (9), and evaluated. The measuring device 13 optionally has a control device 43 that is connected to the light source (8) and the sensor (17). If, in the course of the operation of the measuring device 13, the signals from the reference sensor (17) initiated by the light source (8) deviate from the desired values of the light (6) of the initial state (calibration value), during operation the control device 43 controls/corrects the brightness of the light from the light source to the initial state once again, such that the magnitude of the light (6) leaving the light source (8) remains constant.

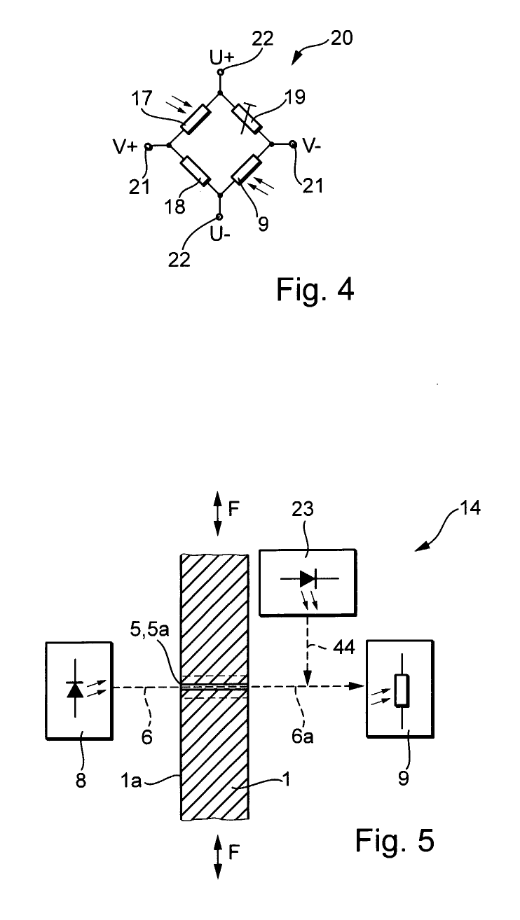

A possible interconnection of the sensors 9 and 17 is shown in FIG. 4 by way of example. These are sensors 9, 17 that change their electric resistance as a function of the intensity of illumination. The sensors 9 and 17 are interconnected with two supplementary resistors 18 and 19 to form a Wheatstone bridge 20. The variable resistor 19 serves the purpose of balancing the bridge 20. The bridge 20 is supplied with a constant voltage 21 (V+ and V−). The voltage 22 (U+ and U−) is tacked as the output signal of the arrangement. The component 1 is already loaded with a base load, or can be unloaded in the initial state of the loading of the component 1. By setting the resistor 19, the bridge 20 is balanced such that the (initial) voltage 22 is equal to zero in the initial position of the body edge 5a. If, owing to loading, there is now a change in the position of the body edge 5a, and thus in the quantity of light penetrating through the passage 4, the bridge 20 reacts very sensitively with a voltage 22 deviating from zero. Because the sensors 9 and 13 are balanced with one another, the arrangement is insensitive with regard, for example, to temperature fluctuations and aging.

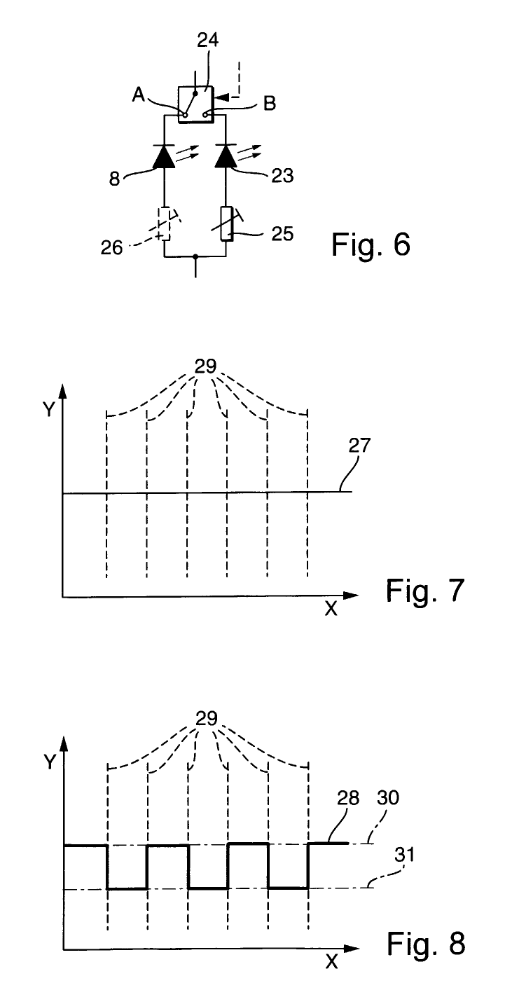

FIG. 5 shows a measuring device 14. The measuring device 14 has a reference light source 23 in addition to the fundamental design of the device 7. The reference light source 23 is fitted directly on or in the vicinity of the sensor 9 and illuminates the latter with the light 6, in a fashion uninfluenced by deformations at the passage 4, with equal intensity. As is to be seen from FIG. 6, the two light sources 8 and 23 are switched on alternately, by switching from the position A to B, within a predetermined frequency by a switchover unit 24. Here, for example, the contact A is assigned to the light source 8, and the contact B to the reference light source 23. Thus, it is always only one of the light sources 8 or 23 that shines at the same time.

The reference light source 23, optionally also the light source 8, can have its/their brightness set via an actuator 25 and/or 26, in this case via a variable resistor. By suitably selecting the switchover frequency between A and B and subsequent frequency-selective evaluation of the output signal, for example interference frequencies of 5 Hz originating in the lighting main, can be effectively suppressed. During balancing of the light sources 8 and 23, the actuator 25 controls the intensity of the light 44 from the light source 23 to the magnitude of the portion 6a of the light 6 from the light source 8 in the initial state of the component 1. The quantities of light 6a and 44 that are recorded by the sensor 9 from both light sources 8 and 23 are therefore of exactly the same magnitude in the initial position of the body edge 5a. FIG. 7 illustrates graphically that the switchover points 29 (from A to B and vice versa) to signal 27 of sensor 9 are not perceivable in this state. Here, the Y-axis stands for the value of the signal (for example voltage), and the X-axis for time.

If the component 1 is loaded or relieved in a fashion deviating from the initial state, the position of the body edge 5a and the quantity of light 6a for the light source 8 change. The quantities of light recorded by the sensor 9 now deviate from one another, since the light 44 has not been varied by comparison with the initial state. This produces the signal 28 at the sensor 9 that is shown in FIG. 8. The difference in magnitude is noticeable in the vertical distance between the two imaginary values of maximum value 30 and minimum value 31. An alternating signal is produced which has the switchover frequency (from A to B and vice versa) whose amplitude (distance between the values 30 and 31) is evaluated in the evaluation device as a measure of the loading of the component. In a departure from the square wave voltage, illustrated here, resulting from a sudden switchover from A to B, other processes of the signal are possible (for example in wave form—sinusoidal, serrations etc). The previously described arrangement is very reliable against interference frequencies, since the alternating signal can be evaluated in a frequency selective fashion with the known switchover frequency.

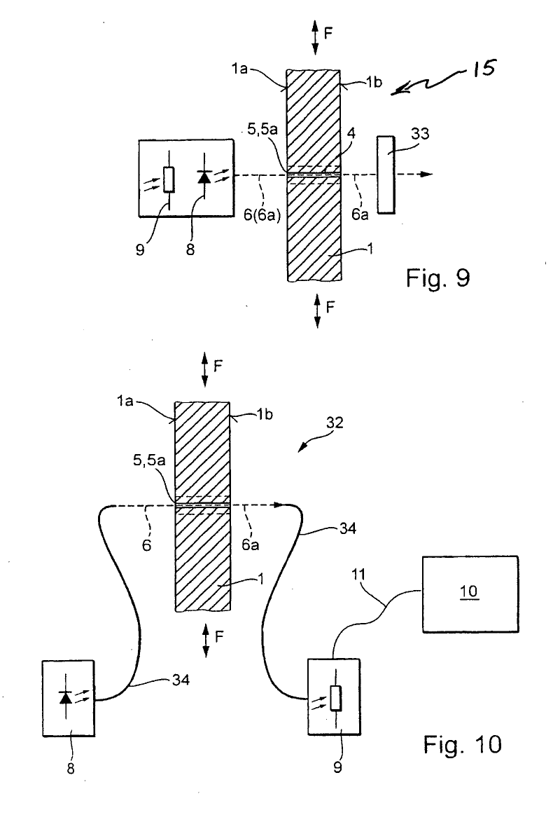

FIG. 9 shows a measuring device 15 in which the light source 8 is arranged on one side la of the component 1, and the sensor 9 is arranged on the same side. On side 1b, the light 6a strikes a reflector 33 and is reflected by the latter onto the sensor 9 through the passage 4.

FIG. 10 shows a measuring device 32 in which the light source 8 and the sensor 9 are arranged further away from the component 1 and the passage 4. The light 6 and its portions 6a and 6b are guided to the passage 4 by means of light guiding media in light guides 34.

### LIST OF REFERENCE NUMERALS

1 Component
1a Side
1b Side
2 Projection
3 Bearing component
4 Passage
5 Measuring edge
5a Body edge
6 Light
6a Portion
6b Portion
7 Measuring device
8 Light source
9 Sensor
10 Evaluation unit
11 Connection
12 Double arrow
13 Measuring device
14 Measuring device
15 Measuring device
16 Sensor
17 Sensor
18 Supplementary resistor
19 Supplementary resistor
20 Wheatstone bridge
21 Constant voltage
22 Voltage
23 Reference light source
24 Switchover unit
25 Actuator
26 Actuator
27 Signal
28 Signal
29 Switchover unit
30 Maximum value
31 Minimum value
32 Measuring device
33 Reflector
34 Light guide
35 Rolling bearing
36 Rolling bodies
37 Tangential passage
38 Passage
39 Passage
40 Passage
41 Passage hole
42 Inner ring
43 Control device
44 Light

1. A measuring device for measuring changes in at least one position of at least one body edge of a component, the measuring device comprising: at least one sensor reacting to the changes, wherein the measuring device has at least one light source, at least one measuring edge that is fixed in relation to the body edge, and at least one light emanating from the light source, it being possible for the measuring edge to vary its position by comparison with the light at least from an initial position, and a portion of the light that has been changed in size by changes in the position by comparison with the initial position of the measuring edge(s) strikes the sensor without impediment.

2. The measuring device of claim 1, wherein the measuring edge is the body edge.

3. The measuring device of claim 2, wherein the body edge delimits a variable passage that passes through the component and through which the portion of the light strikes the sensor.

4. The measuring device of claim 1, wherein the position of the measuring edge varied from the initial position by comparison with the light at the same time:
a first portion of the light strikes the sensor without impediment, and
at least one second portion of the light strikes at least the measuring edge,
and it being possible for the first portion and the second portion of the light to be changed in size relative to one another by changes in the position of the measuring edge from the initial position.

5. The measuring device of claim 4, wherein the position of the measuring edge varied from the initial position by comparison with the light at the same time:
at least two of the second portions of the light respectively strike the measuring edge at another location,
it being possible for the first portion and at least one of the second portions of the light to be changed in size relative to one another by deviations in the position of the measuring edge from the initial position.

6. The measuring device of claim 1, wherein the light source and the sensor are situated opposite one another and a portion of the light strikes the measuring edge between the light source and the sensor.

7. The measuring device of claim 1, further comprising a reflector is situated opposite the light source, the reflector reflecting the light at least intermittently and at least partially to the sensor, and the light striking the measuring edge at least partially between the light source and the reflector.

8. The measuring device of claim 1, wherein the measuring device has a first sensor and at least a second sensor, and in the position varied from the initial position of the measuring edge by comparison with the light at the same time:
a first portion of the light strikes the first sensor without impediment and in this case,
at least one second portion of the light strikes at least the measuring edge,
the first portion and the second portion of the light being changed in size relative to one another by deviations in the position of the measuring edge from the initial position, and
the first portion and the second portion of the light striking the second sensor at least partially in a fashion equaling the initial state in size and thus independently of the changes in the position.

9. The measuring device of claim 8, wherein the measuring device has a control device, the control device being connected to the second sensor and the light source.

10. The measuring device of claim 1, wherein the measuring device has at least one reference light source with a reference light, the reference light equaling at least the light in an initial position of the measuring edge, and in the position of the measuring edge that has been changed relative to the initial position, at the same time:
a first portion of the light from the light source strikes the sensor without impediment,
at least one second portion of the light from the light source strikes at least the measuring edge, and
the first portion and the second portion are changed in size relative to one another by deviations in the position of the measuring edge from the initial position, and
the reference light, unchanged in comparison to the initial position, of the reference light source, strikes the sensor in alternating sequence with the first portion of the light source, changed relative to the initial position.

11. The measuring device of claim 1, wherein the measuring device has at least one light guiding medium with the aid of which at least portions of the light are guided into the measuring device.

12. The measuring device of claim 11, wherein the light guiding medium is in at least one fiber optics cable.

13. The measuring device of claim 1, wherein the component is assigned to at least one rotary and/or linear bearing.
